(19) United States
(12) Patent Application Publication
(10) Pub. No.: US 2013/0043607 A1
(43) Pub. Date: Feb. 21, 2013

(54) APPARATUS AND METHOD FOR CORRECTING WARPING OF LIGHT GUIDE PLATE

(71) Applicants: Tai-Cherng Yu, Tu-Cheng (TW); Da-Wei Lin, Tu-Cheng (TW)

(72) Inventors: Tai-Cherng Yu, Tu-Cheng (TW); Da-Wei Lin, Tu-Cheng (TW)

(73) Assignee: HON HAI PRECISION INDUSTRY CO., LTD., Tu-Cheng (TW)

(21) Appl. No.: 13/523,868

(22) Filed: Jun. 14, 2012

(30) Foreign Application Priority Data
Aug. 19, 2011 (TW) 100129652

(51) Int. Cl. G02B 6/00

(52) U.S. Cl. 264/1.27; 425/11

(57) ABSTRACT

An apparatus for correcting any warping of a light guide plate includes a retaining device and a heating device. The retaining device includes a top pressing plate, a bottom supporting plate and an oil hydraulic cylinder on the top pressing plate. The oil hydraulic cylinder applies a pressing force on the top pressing plate, and the top pressing plate and the bottom supporting plate cooperatively sandwich and retain a light guide plate. The heating device has a coil of wire for surrounding the light guide plate. The coil of wire is configured for heating the light guide plate, the pressure and the heat thereby correcting the warp of the light guide plate. A method for correcting a warp of a light guide plate is also provided.

### BACKGROUND

1. Technical Field

The present disclosure relates to an apparatus for correcting warping of one or more light guide plates and a method for realizing same.

2. Description of Related Art

IT products become thinner and thinner. Light guide plates are used in many IT products. An LED backlight module may be used in a 14 inch notebook computer for example, and the thickness of a light guide plate used in the LED backlight module may be less than 1 mm. Such a thin light guide plate is a challenge in both the injection molding and the warping control after injection molding.

Stress remains in light guide plates molded by injection molding and the light guide plate easily absorbs water, such that warping easily occurs after the light guide plates cool down. Warping in light guide plates may cause non-uniform brightness.

What is needed, therefore, is an apparatus and a method for correcting a warping of a light guide plate, which can overcome the above shortcomings.

### BRIEF DESCRIPTION OF THE DRAWINGS

Many aspects of the present apparatus and method can be better understood with reference to the following drawings. The components in the drawings are not necessarily drawn to scale, the emphasis instead being placed upon clearly illustrating the principles of the present apparatus and method. Moreover, in the drawings, like reference numerals designate corresponding parts throughout the several views.

FIG. 1 is a schematic view of an apparatus for correcting warping of a number of light guide plates in accordance with a first embodiment.

FIG. 2 shows the light guide plates corrected by the apparatus of FIG. 1.

### DETAILED DESCRIPTION

Embodiments of the present apparatus and method for correcting one or more warped light guide plates will be described with reference to the drawings.

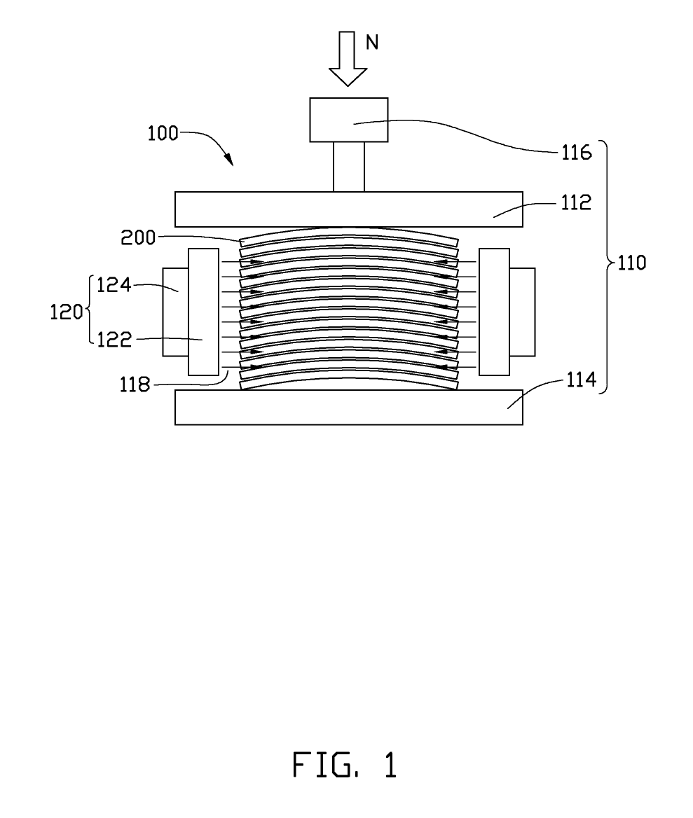

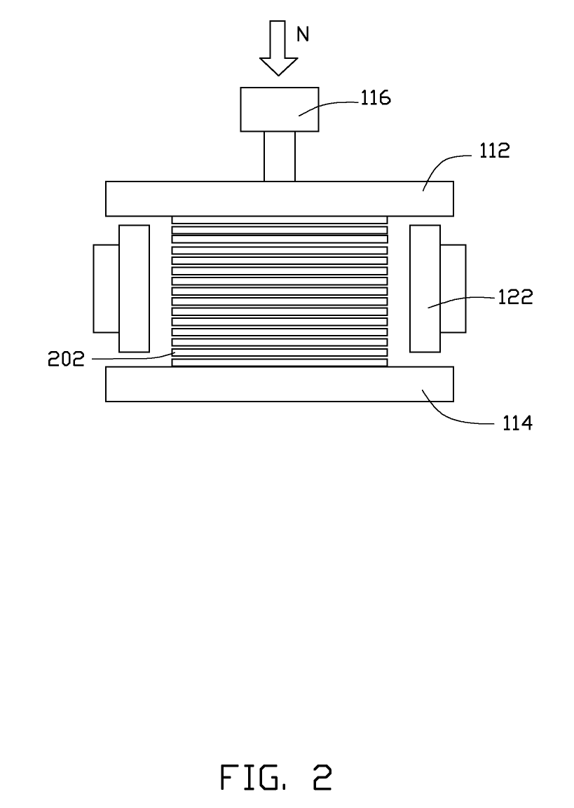

Referring to FIGS. 1 and 2, an apparatus 100 for correcting a warping of a light guide plate 200 is provided. The apparatus 100 includes a retaining device 110 and a heating device 120. The retaining device 110 includes a top pressing plate 112, a bottom supporting plate 114 and an oil hydraulic cylinder 116. The top pressing plate 112 and the bottom supporting plate 114 are configured for cooperatively sandwiching and retaining one or more warped light guide plates 200 to be corrected. The more than one light guide plates 200 can be stacked.

The top pressing plate 112 and the bottom supporting plate 114 are arranged parallel with each other, and each of the top pressing plate 112 and the bottom supporting plate 114 has a flat surface substantially parallel to the light guide plates 200.

The oil hydraulic cylinder 116 abuts the top pressing plate 112, and is configured for applying pressure on the top pressing plate 112, such that the top pressing plate 112 presses the light guide plates 200 toward the bottom supporting plate 114. The oil hydraulic cylinder 116 uses oil as a pressurized hydraulic fluid, and the oil hydraulic cylinder 116 may have a piston to transform the power of the oil to be a linear pressing force applied on the top pressing plate 112. In the present embodiment, the linear pressing force is along a direction N which is perpendicular to the surface of the top pressing plate 112. In an alternative embodiment, the oil hydraulic cylinder 116 can be integrally formed with the top pressing plate 112, and thus a space between the top pressing plate 112 and the bottom supporting plate 114 can be adjusted by the oil hydraulic cylinder 116.

The heating device 120 is located between the top pressing plate 112 and the bottom supporting plate 114. The heating device 120 mainly includes coils of wire 122 surrounding the light guide plates 200, and a control device 124 arranged around the coils of wire 122 and configured for electrifying the coils of wire 122. The coils of wire 122 form a receiving space 118 receiving the light guide plates 200, and the light guide plates are spaced a distance from the coils of wire 122. The coils of wire 122 are electrically connected to the control device 124, and the control device 124 can have a resonant cavity for oscillating electrons in the coils of wire 122. In this way, when the coils of wire 122 are electrified, electromagnetic waves with a certain frequency can be generated in the receiving space 118, and the frequency can be controlled by the control device 124. The electromagnetic waves heat the light guide plates 200 to correct the warping of the light guide plates 200. According to experiments, electromagnetic waves with a frequency in a range from 2400 MHz to 3000 MHz have best results for releasing stress in the light guide plates 200, thereby correcting the warping of the light guide plates 200, within a time of usually 1 hour.

The process can apply a frequency of a little greater than 3000 MHz or a little less than 2400 MHz according to the number of the light guide plates 200 to be corrected. Preferably, the electromagnetic waves with a frequency 2450 MHz are applied, because that is a microwave frequency, which is safer for operators, and the configuration of the control device 124 can be made similar to those of microwave ovens.

The coils of wire 122 can be connected in series, or connected in parallel. The coils of wire 122 are resilient in height, such that the coils of wire 122 can be compressed during the operation of oil hydraulic cylinder 116.

An air space is maintained between the coils of wire 122 and the light guide plates 200, thus facilitating the propagation of the electromagnetic waves in the receiving space 118. The coils of wire 122 are not in contact with the light guide plates 122, and cause no damage to any surfaces of the light guide plates 122.

A method for correcting a warping of one or more light guide plates may include the following steps.

First, stack one or more warped light guide plates 200 on the bottom supporting plate 114 in the receiving space 118 of the heating device 120. An air space is maintained between the coils of wire 122 and the light guide plates 200 to avoid contact with any surfaces of the light guide plates 122.

Second, apply the top pressing plate 112 on the light guide plates 200 and apply the oil hydraulic cylinder 116 to the top pressing plate 112. The oil hydraulic cylinder 116 applies a linear pressing force on the top pressing plate 112, thereby compressing the light guide plate 200.

Third, heat the light guide plates 200 using electromagnetic waves generated by the heating device 120. The pressure of the oil hydraulic cylinder 116 is maintained on the top pressing plate 112 during the heating of the light guide plates 200. The electromagnetic waves induce resonance of molecules of the light guide plates 200, thereby over time releasing stress in the light guide plates 200, and thus correcting the warping of the light guide plates 200.

A constant linear pressing force can be maintained throughout the process. Alternatively, the linear pressing force can be adjusted to gradually increase during correcting the warping of the light guide plates 200.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An apparatus for correcting a warping of a light guide plate, the apparatus comprising:
a retaining device comprising a top pressing plate, a bottom supporting plate and an oil hydraulic cylinder abutting on the top pressing plate, the oil hydraulic cylinder configured for applying a pressing force on the top pressing plate, the top pressing plate and the bottom supporting plate cooperatively sandwiching and retaining a light guide plate therebetween; and
a heating device comprising a coil of wire for surrounding the light guide plate, the coil of wire configured for generating an electromagnetic wave for heating the light guide plate, thereby correcting the warping of the light guide plate.

2. The apparatus of claim 1, wherein the top pressing plate and the bottom supporting plate are parallel with each other, and each of the top pressing plate and the bottom supporting plate comprises a flat surface facing the light guide plate.

3. The apparatus of claim 2, wherein the pressing force is a linear pressing force along a direction perpendicular to the flat surface.

4. The apparatus of claim 1, wherein the coil of wire is configured to spaced a distance from and the light guide plate.

5. The apparatus of claim 1, wherein the heating device further comprises a control device for controlling a frequency of the electromagnetic wave.

6. The apparatus of claim 5, wherein a frequency of the electromagnetic wave is in a range from 2400 MHz to 3000 MHz.

7. The apparatus of claim 6, wherein a frequency of the electromagnetic wave is 2450 MHz.

8. A method for correcting a warping of a light guide plate, the method comprising:
placing a warped light guide plate between a top pressing plate and a bottom supporting plate;
pressing the top pressing plate toward the bottom supporting plate using an oil hydraulic cylinder;
disposing the light guide plate within a coil of wire; and
generating a electromagnetic wave using the coil of wire to heat the light guide plate, thereby correcting the warping of the light guide plate.

9. The method of claim 8, wherein the light guide plate is pressurized by the top pressing plate and the bottom supporting plate during the heating of the light guide plate.

10. The method of claim 9, wherein the oil hydraulic cylinder is configured to apply a pressing force on the top pressing plate, the pressing force is maintained constant or increases gradually.

11. The method of claim 10, wherein the top pressing plate comprises a flat surface facing the light guide plate, and the pressing force is a linear pressing force along a direction perpendicular to the surface.

12. The method of claim 8, wherein an air space is maintained between the coil of wire and the light guide plate.

13. The method of claim 8, wherein a frequency of the electromagnetic wave is in a range from 2400 MHz to 3000 MHz.

14. The method of claim 13, wherein a frequency of the electromagnetic wave is 2450 MHz.

15. The method of claim 13, wherein the light guide plate is heated for a time period of less than 1 hour.

16. A method for correcting a plurality of warped light guide plates, the method comprising:
stacking a plurality of warped light guide plates between a top pressing plate and a bottom supporting plate;
surrounding the warped light guide plates within coils of wire;
pressing the top pressing plate toward the bottom supporting plate using an oil hydraulic cylinder; and
generating a electromagnetic wave using the coils of wire to heat the warped light guide plates, thereby correcting the warped light guide plates.
